(19) United States
(12) Patent Application Publication
(10) Pub. No.: US 2015/0200587 A1
(43) Pub. Date: Jul. 16, 2015

(54) POWER CONVERSION APPARATUS

(71) Applicant: Chicony Power Technology Co., Ltd., New Tapei City (TW)

(72) Inventors: Chao-Jui HUANG, New Taipei City (TW); Chu-Chen YANG, New Taipei City (TW); Wei-Shan YEH, New Taipei City (TW)

(21) Appl. No.: 14/334,798

(22) Filed: Jul. 18, 2014

(30) Foreign Application Priority Data
Jan. 14, 2014 (TW) 103101333

(51) Int. Cl. H02M 1/42; H02M 3/335

(52) U.S. Cl. CPC H02M 1/4208; H02M 3/33507

(57) ABSTRACT

A power conversion apparatus (10) includes a transformer (108), a primary side switch (110), a primary side switch control unit (112), a mode change-over switch (122), a mode change-over switch control unit (124), a secondary side switch (128) and a secondary side switch control unit (130). The primary side switch control unit (112) is configured to turn off the primary side switch (110) and the secondary side switch control unit (130) is configured to turn on the secondary side switch (128) if the power conversion apparatus (10) is operated in a reactive power area. The mode change-over switch control unit (124) is configured to turn off the mode change-over switch (122). Therefore, the power conversion apparatus (10) has functions of a flyback power converter and a function of reactive power compensation.

### BACKGROUND OF THE INVENTION

1. Field of the Invention

The present invention relates to a power conversion apparatus, and especially relates to a power conversion apparatus having reactive power compensation.

2. Description of the Related Art

The reboost power conversion apparatus has the advantages of high efficiency and high voltage boost ratio. Therefore, the reboost power conversion apparatus is used widely.

FIG. 1 shows a waveform diagram of an embodiment of an output voltage of a conventional reboost power conversion apparatus. The disadvantage of the reboost power conversion apparatus is that the lowest output voltage of the reboost power conversion apparatus will be clamped with the input voltage (the horizontal line of the waveform). The lowest output voltage of the reboost power conversion apparatus cannot be zero if the input voltage is not zero, as shown in FIG. 1.

Therefore, the conventional reboost power conversion apparatus can be used as a boost inverter only. The conventional reboost power conversion apparatus cannot be applied to a power supply which outputs an alternating current power, for example, a micro inverter. FIG. 2 shows a waveform diagram of an embodiment of an output voltage of a power conversion apparatus which is applicable to a power supply outputting an alternating current power. FIG. 3 shows a waveform diagram showing that the output voltage shown in FIG. 2 is inverted. The output voltage (as shown in FIG. 1) of the conventional reboost power conversion apparatus cannot be the perfect zero-crossing (as shown in FIG. 3) after inverting. Therefore, the conventional reboost power conversion apparatus cannot be applied to the power supply which outputs the alternating current power.

Moreover, FIG. 7 shows a waveform diagram of the output voltage and the output current for the reactive power compensation or the reactive power control of the conventional reboost power conversion apparatus (or the conventional flyback power conversion apparatus). The output current will be zero when the polarity of the output current is different from the polarity of the output voltage. A diode is arranged in the secondary side of a transformer of the conventional reboost power conversion apparatus (or the conventional flyback power conversion apparatus), so that the current is unidirectional. Therefore, the conventional reboost power conversion apparatus (or the conventional flyback power conversion apparatus) cannot be applied to the reactive power compensation products or the reactive power control products.

### SUMMARY OF THE INVENTION

In order to solve the above-mentioned problems, an object of the present invention is to provide a power conversion apparatus.

In order to solve the above-mentioned problems, another object of the present invention is to provide a power conversion apparatus.

In order to achieve the object of the present invention mentioned above, the power conversion apparatus comprises a power input side, a power output side, a power negative side, a transformer, a primary side switch, a primary side switch control unit, a first unidirectional conduction unit, a first electric charge storage unit, a second electric charge storage unit, a second unidirectional conduction unit, a mode change-over switch, a mode change-over switch control unit, a secondary side switch, a secondary side switch control unit and a fourth unidirectional conduction unit. The transformer is electrically connected to the power input side. The primary side switch is electrically connected to the transformer and the power negative side. The primary side switch control unit is electrically connected to the primary side switch. The first unidirectional conduction unit is electrically connected to the transformer and the power output side. The first electric charge storage unit is electrically connected to the transformer and the power output side. The second electric charge storage unit is electrically connected to the transformer, the first electric charge storage unit and the power negative side. The second unidirectional conduction unit is electrically connected to the transformer and the primary side switch. The mode change-over switch is electrically connected to the second unidirectional conduction unit, the transformer, the first electric charge storage unit and the second electric charge storage unit. The mode change-over switch control unit is electrically connected to the mode change-over switch. The secondary side switch is electrically connected to the transformer, the power output side and the first unidirectional conduction unit. The secondary side switch control unit is electrically connected to the secondary side switch. The fourth unidirectional conduction unit is electrically connected to the primary side switch. The power conversion apparatus is operated in an active power area if a value of an alternating voltage of the power output side multiplied by a value of an alternating current of the power output side is not less than zero. The power conversion apparatus is operated in a reactive power area if the value of the alternating voltage of the power output side multiplied by the value of the alternating current of the power output side is less than zero. If the power conversion apparatus is operated in the active power area and an absolute value of the alternating voltage of the power output side is greater than an absolute value of an input voltage of the power input side, the mode change-over switch control unit is configured to turn on the mode change-over switch, so that the power conversion apparatus has functions of a reboost power converter. If the power conversion apparatus is operated in the active power area and the absolute value of the alternating voltage of the power output side is not greater than the absolute value of the input voltage of the power input side, the mode change-over switch control unit is configured to turn off the mode change-over switch, so that the power conversion apparatus has functions of a flyback power converter. The primary side switch control unit is configured to turn off the primary side switch and the secondary side switch control unit is configured to turn on the secondary side switch if the power conversion apparatus is operated in the reactive power area. The mode change-over switch control unit is configured to turn off the mode change-over switch. Therefore, the power conversion apparatus has functions of the flyback power converter and a function of reactive power compensation.

In order to achieve another object of the present invention mentioned above, the power conversion apparatus comprises a power input side, a power output side, a power negative side, a transformer, a primary side switch, a primary side switch control unit, a first unidirectional conduction unit, a first electric charge storage unit, a secondary side switch and a secondary side switch control unit. The transformer is electrically connected to the power input side. The primary side switch is electrically connected to the transformer and the power negative side. The primary side switch control unit is electrically connected to the primary side switch. The first unidirectional conduction unit is electrically connected to the transformer and the power output side. The first electric charge storage unit is electrically connected to the transformer and the power output side. The secondary side switch is electrically connected to the transformer, the power output side and the first unidirectional conduction unit. The secondary side switch control unit is electrically connected to the secondary side switch. The power conversion apparatus is operated in an active power area if a value of an alternating voltage of the power output side multiplied by a value of an alternating current of the power output side is not less than zero. The power conversion apparatus is operated in a reactive power area if the value of the alternating voltage of the power output side multiplied by the value of the alternating current of the power output side is less than zero. The primary side switch control unit is configured to turn off the primary side switch and the secondary side switch control unit is configured to turn on the secondary side switch if the power conversion apparatus is operated in the reactive power area. Therefore, the power conversion apparatus has a function of reactive power compensation.

The efficiency of the present invention is that the lowest output voltage of the reboost power conversion apparatus can be zero, so that the reboost power conversion apparatus can be applied to the power supply which outputs the alternating current power. Moreover, the reboost power conversion apparatus (or the flyback power conversion apparatus) can be applied to the reactive power compensation products or the reactive power control products because the current is bidirectional (flowing through the secondary side switch).

### BRIEF DESCRIPTION OF DRAWING

FIG. 1 shows a waveform diagram of an embodiment of an output voltage of a conventional reboost power conversion apparatus.

FIG. 2 shows a waveform diagram of an embodiment of an output voltage of a power conversion apparatus which is applicable to a power supply outputting an alternating current power.

FIG. 3 shows a waveform diagram showing that the output voltage shown in FIG. 2 is inverted.

FIG. 4 shows a block diagram of the first embodiment of the power conversion apparatus of the present invention.

FIG. 5 shows a block diagram of the second embodiment of the power conversion apparatus of the present invention.

FIG. 6 shows a block diagram of the third embodiment of the power conversion apparatus of the present invention.

FIG. 7 shows a waveform diagram of the output voltage and the output current for the reactive power compensation or the reactive power control of the conventional reboost power conversion apparatus (or the conventional flyback power conversion apparatus).

FIG. 8 shows a waveform diagram of the output voltage and the output current for the reactive power compensation or the reactive power control of the power conversion apparatus of the present invention.

FIG. 9 shows a block diagram of the first application embodiment of the power conversion apparatus of the present invention.

FIG. 10 shows a block diagram of the second application embodiment of the power conversion apparatus of the present invention.

### DETAILED DESCRIPTION OF THE INVENTION

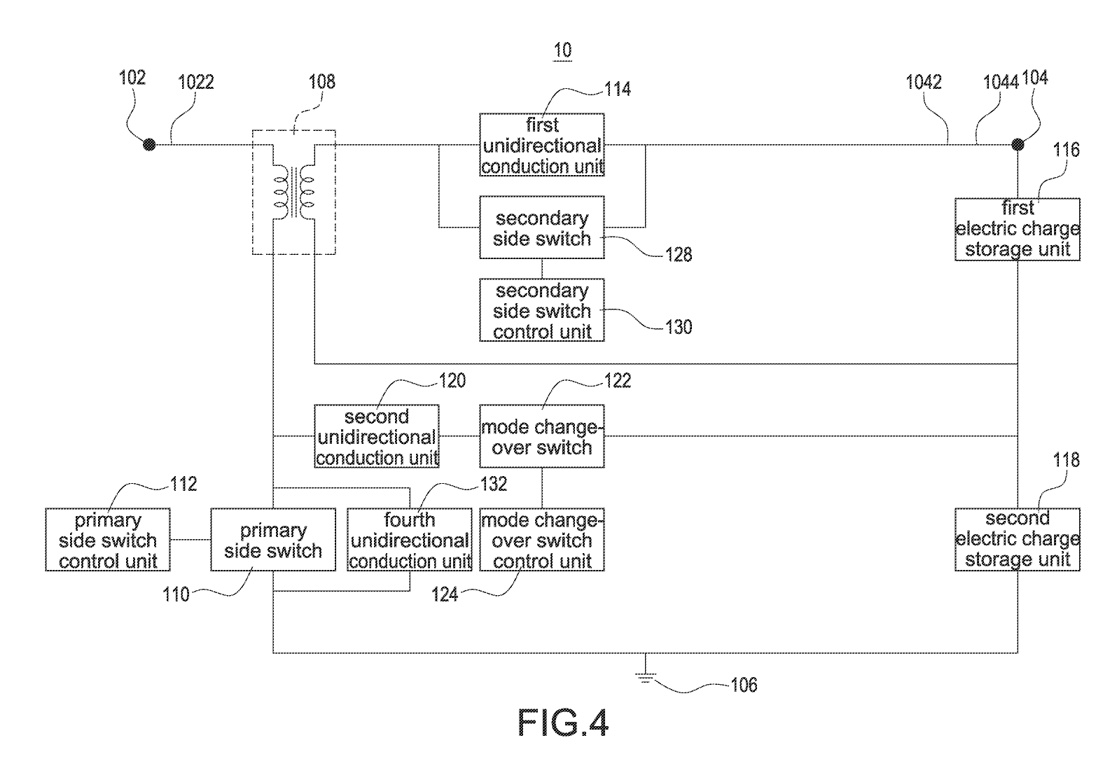

FIG. 4 shows a block diagram of the first embodiment of the power conversion apparatus of the present invention. A power conversion apparatus 10 comprises a power input side 102, a power output side 104, a power negative side 106, a transformer 108, a primary side switch 110, a primary side switch control unit 112, a first unidirectional conduction unit 114, a first electric charge storage unit 116, a second electric charge storage unit 118, a second unidirectional conduction unit 120, a mode change-over switch 122, a mode change-over switch control unit 124, a secondary side switch 128, a secondary side switch control unit 130 and a fourth unidirectional conduction unit 132.

The transformer 108 is electrically connected to the power input side 102. The primary side switch 110 is electrically connected to the transformer 108 and the power negative side 106. The primary side switch control unit 112 is electrically connected to the primary side switch 110. The first unidirectional conduction unit 114 is electrically connected to the transformer 108 and the power output side 104. The first electric charge storage unit 116 is electrically connected to the transformer 108 and the power output side 104. The second electric charge storage unit 118 is electrically connected to the transformer 108, the first electric charge storage unit 116 and the power negative side 106. The second unidirectional conduction unit 120 is electrically connected to the transformer 108 and the primary side switch 110. The mode change-over switch 122 is electrically connected to the second unidirectional conduction unit 120, the transformer 108, the first electric charge storage unit 116 and the second electric charge storage unit 118. The mode change-over switch control unit 124 is electrically connected to the mode change-over switch 122. The secondary side switch 128 is electrically connected to the transformer 108, the power output side 104 and the first unidirectional conduction unit 114. The secondary side switch control unit 130 is electrically connected to the secondary side switch 128. The fourth unidirectional conduction unit 132 is electrically connected to the primary side switch 110.

The power conversion apparatus 10 has functions of a reboost power converter when the mode change-over switch control unit 124 is configured to turn on the mode change-over switch 122. The power conversion apparatus 10 has functions of a flyback power converter when the mode change-over switch control unit 124 is configured to turn off the mode change-over switch 122.

When a lowest output voltage of the power conversion apparatus 10 is clamped with an input voltage 1022, the mode change-over switch control unit 124 is configured to turn off the mode change-over switch 122, so that the power conversion apparatus 10 becomes thr flyback power converter to overcome this problem. When the lowest output voltage of the power conversion apparatus 10 is not clamped with the input voltage 1022, the mode change-over switch control unit 124 is configured to turn on the mode change-over switch 122, so that the power conversion apparatus 10 becomes the reboost power converter.

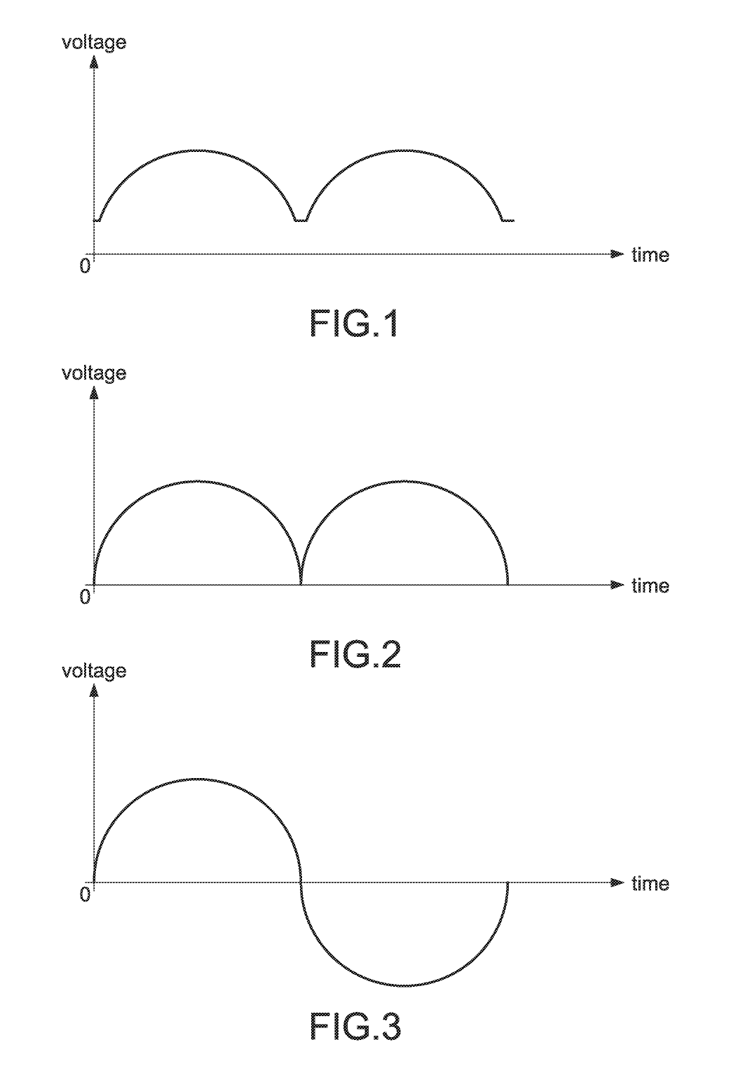

Therefore, a waveform of an alternating voltage 1042 of the power conversion apparatus 10 is shown as FIG. 2, which is different from FIG. 1. The power conversion apparatus 10 will be applicable to a power supply (not shown in FIG. 4) which outputs an alternating current power.

In another word, when the lowest output voltage of the power conversion apparatus 10 is clamped with the input voltage 1022, the power conversion apparatus 10 becomes the flyback power converter, so that the alternating voltage 1042 of the power conversion apparatus 10 can be lower than the input voltage 1022. The lowest output voltage of the power conversion apparatus 10 can be zero.

In an embodiment, if the input voltage 1022 is an alternating current power (sinusoidal wave), the mode change-over switch control unit 124 is configured to turn off the mode change-over switch 122 once a half of a cycle of the input voltage 1022, so that the power conversion apparatus 10 becomes the flyback power converter. In the rest of the time, the mode change-over switch control unit 124 is configured to turn on the mode change-over switch 122, so that the power conversion apparatus 10 becomes the reboost power converter. For example, the mode change-over switch control unit 124 is configured to turn off the mode change-over switch 122 once 1/120 second if the cycle of the alternating current power is 1/60 second.

In another embodiment, the power conversion apparatus 10 further comprises a power input side voltage detector (not shown in FIG. 4) and a power output side voltage detector (not shown in FIG. 4). The power input side voltage detector is electrically connected to the power input side 102 and the mode change-over switch control unit 124. The power output side voltage detector is electrically connected to the power output side 104 and the mode change-over switch control unit 124. The power input side voltage detector detects a voltage of the power input side 102 and then informs the mode change-over switch control unit 124 of the voltage of the power input side 102. The power output side voltage detector detects a voltage of the power output side 104 and then informs the mode change-over switch control unit 124 of the voltage of the power output side 104.

When the absolute value of the alternating voltage 1042 is greater than the absolute value of the input voltage 1022, the mode change-over switch control unit 124 is configured to turn on the mode change-over switch 122, so that the power conversion apparatus 10 becomes the reboost power converter. When the absolute value of the alternating voltage 1042 is not greater than the absolute value of the input voltage 1022, the mode change-over switch control unit 124 is configured to turn off the mode change-over switch 122, so that the power conversion apparatus 10 becomes the flyback power converter.

An alternating current inverting circuit, such as a full bridge circuit, can be arranged in the power input side 102 or the power output side 104 of the power conversion apparatus 10. Therefore, the power conversion apparatus 10 can be applicable to the direct current to direct current area, the direct current to alternating current area (for example, a micro inverter), the alternating current to direct current area or the alternating current to alternating current area. The primary side switch control unit 112 is configured to control the primary side switch 110 with pulse width modulation (such as DCM, CCM, BCM or QR mode, and so on).

Moreover, the power conversion apparatus 10 is operated in an active power area if a value of the alternating voltage 1042 of the power output side 104 multiplied by a value of an alternating current 1044 of the power output side 104 is not less than zero. The power conversion apparatus 10 is operated in a reactive power area if the value of the alternating voltage 1042 of the power output side 104 multiplied by the value of the alternating current 1044 of the power output side 104 is less than zero.

In an embodiment, the power conversion apparatus 10 further comprises a first voltage detector (not shown in FIG. 4), a first current detector (not shown in FIG. 4) and a microprocessor (not shown in FIG. 4). The first voltage detector is electrically connected to the power output side 104. The first current detector is electrically connected to the power output side 104. The microprocessor is electrically connected to the first voltage detector, the first current detector, the primary side switch control unit 112, the secondary side switch control unit 130 and the mode change-over switch control unit 124.

The first voltage detector detects the voltage of the power output side 104 and then informs the microprocessor of the voltage of the power output side 104. The first current detector detects the current of the power output side 104 and then informs the microprocessor of the current of the power output side 104. Therefore, the microprocessor is configured to calculate and derive whether the power conversion apparatus 10 is operated in the active power area or in the reactive power area, and then inform the primary side switch control unit 112, the secondary side switch control unit 130 and the mode change-over switch control unit 124 of whether the power conversion apparatus 10 is operated in the active power area or in the reactive power area.

If the power conversion apparatus 10 is operated in the active power area and an absolute value of the alternating voltage 1042 of the power output side 104 is greater than an absolute value of an input voltage 1022 of the power input side 102, the mode change-over switch control unit 124 is configured to turn on the mode change-over switch 122, so that the power conversion apparatus 10 has functions of a reboost power converter.

If the power conversion apparatus 10 is operated in the active power area and the absolute value of the alternating voltage 1042 of the power output side 104 is not greater than the absolute value of the input voltage 1022 of the power input side 102, the mode change-over switch control unit 124 is configured to turn off the mode change-over switch 122, so that the power conversion apparatus 10 has functions of a flyback power converter.

The primary side switch control unit 112 is configured to turn off the primary side switch 110 and the secondary side switch control unit 130 is configured to turn on the secondary side switch 128 (the current is bidirectional) if the power conversion apparatus 10 is operated in the reactive power area. The mode change-over switch control unit 124 is configured to turn off the mode change-over switch 122. Therefore, the power conversion apparatus 10 has functions of the flyback power converter and the function of reactive power compensation. FIG. 8 shows a waveform diagram of the output voltage and the output current for the reactive power compensation or the reactive power control of the power conversion apparatus of the present invention.

The secondary side switch control unit 130 is configured to turn off the secondary side switch 128 when the power conversion apparatus 10 is operated in the active power area. Or the secondary side switch control unit 130 is configured to turn on the secondary side switch 128 when the primary side switch control unit 112 is configured to turn off the primary side switch 110. The secondary side switch control unit 130 is configured to turn off the secondary side switch 128 when the primary side switch control unit 112 is configured to turn on the primary side switch 110. Therefore, the purpose of synchronous rectification can be achieved to improve efficiency.

The primary side switch 110 is, for example but not limited to, a transistor switch. The first unidirectional conduction unit 114 is, for example but not limited to, a first diode. A cathode of the first diode is electrically connected to the power output side 104. An anode of the first diode is electrically connected to the transformer 108. The first electric charge storage unit 116 is, for example but not limited to, a capacitor. The second electric charge storage unit 118 is, for example but not limited to, a capacitor. The second unidirectional conduction unit 120 is a second diode. A cathode of the second diode is electrically connected to the mode change-over switch 122. An anode of the second diode is electrically connected to the transformer 108 and the primary side switch 110. The mode change-over switch 122 is, for example but not limited to, a transistor switch. The secondary side switch 128 is, for example but not limited to, a transistor switch.

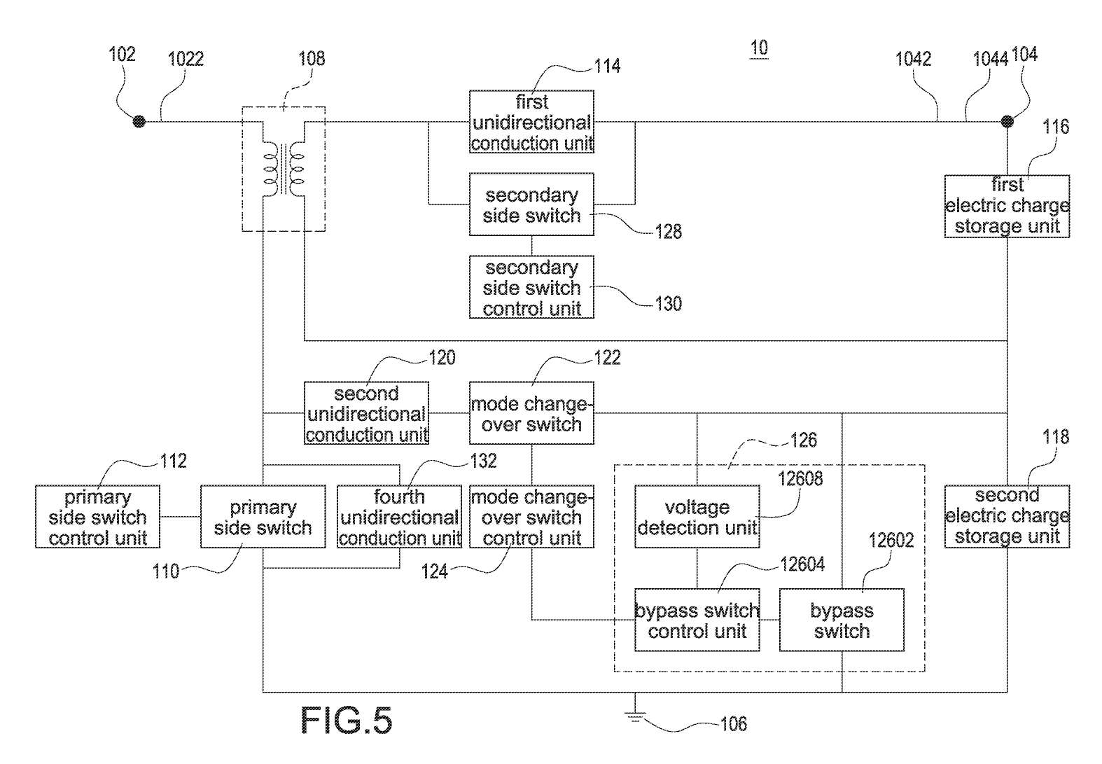

FIG. 5 shows a block diagram of the second embodiment of the power conversion apparatus of the present invention. The description for the elements shown in FIG. 5, which are similar to those shown in FIG. 4, is not repeated here for brevity. Moreover, the power conversion apparatus 10 further comprises a second electric charge storage bypass circuit 126 electrically connected to the transformer 108, the first electric charge storage unit 116, the second electric charge storage unit 118, the mode change-over switch 122 and the power negative side 106.

The second electric charge storage unit 118 discharges to the power negative side 106 accurately according to the second electric charge storage bypass circuit 126 when the mode change-over switch control unit 124 is configured to turn off the mode change-over switch 122.

In another word, the second electric charge storage bypass circuit 126 provides the second electric charge storage unit 118 a bypass path when the power conversion apparatus 10 is a flyback power converter. The voltage of the second electric charge storage unit 118 is insured to be zero. The second electric charge storage unit 118 will not suffer from a negative charging current which causes the voltage of the second electric charge storage unit 118 to be negative.

The second electric charge storage bypass circuit 126 comprises a bypass switch 12602, a bypass switch control unit 12604 and a voltage detection unit 12608. The bypass switch 12602 is electrically connected to the transformer 108, the first electric charge storage unit 116, the second electric charge storage unit 118, the mode change-over switch 122 and the power negative side 106. The bypass switch control unit 12604 is electrically connected to the bypass switch 12602 and the mode change-over switch control unit 124. The voltage detection unit 12608 is electrically connected to the transformer 108, the first electric charge storage unit 116, the second electric charge storage unit 118, the mode change-over switch 122, the bypass switch 12602 and the bypass switch control unit 12604. The bypass switch 12602 is, for example but not limited to, a transistor switch.

When the power conversion apparatus 10 is a flyback power converter, the mode change-over switch control unit 124 informs the bypass switch control unit 12604, and the voltage detection unit 12608 detects the voltage of the second electric charge storage unit 118 and then informs the bypass switch control unit 12604 of the voltage of the second electric charge storage unit 118. The bypass switch control unit 12604 is configured to determine the conduction time of the bypass switch 12602 according to the voltage of the second electric charge storage unit 118.

When the power conversion apparatus 10 is a reboost power converter, the mode change-over switch control unit 124 informs the bypass switch control unit 12604, and the bypass switch control unit 12604 is configured to turn off the bypass switch 12602.

The advantage of the present invention is that the lowest output voltage of the reboost power conversion apparatus can be zero, so that the reboost power conversion apparatus can be applied to the power supply which outputs the alternating current power. Moreover, the reboost power conversion apparatus (or the flyback power conversion apparatus) can be applied to the reactive power compensation products or the reactive power control products because the current is bidirectional (flowing through the secondary side switch 128).

Moreover, the primary side switch 110 and the fourth unidirectional conduction unit 132 can be integrated as a metal oxide semiconductor field effect transistor package or an insulated gate bipolar transistor package. The secondary side switch 128 and the first unidirectional conduction unit 114 can be integrated as a metal oxide semiconductor field effect transistor package or an insulated gate bipolar transistor package.

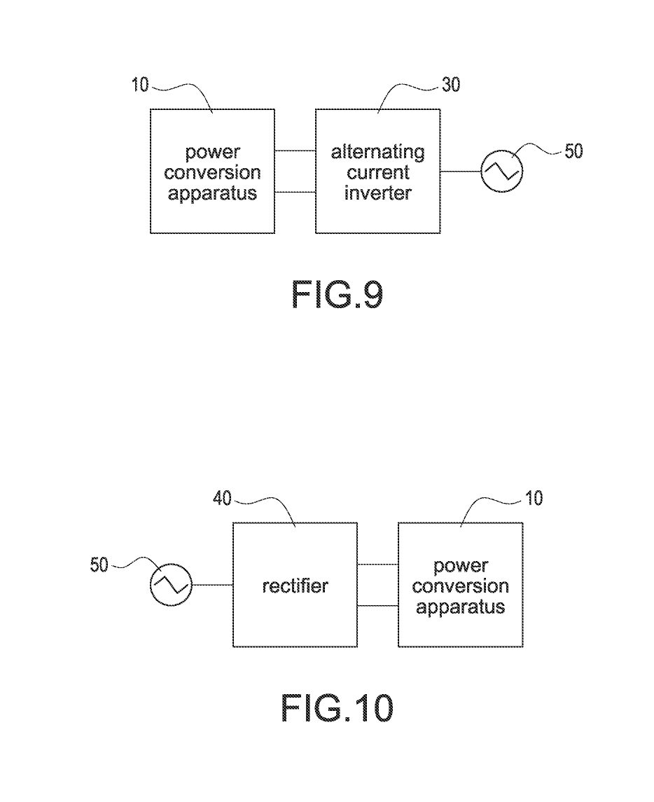

FIG. 9 shows a block diagram of the first application embodiment of the power conversion apparatus of the present invention. An alternating current inverter 30 is arranged in the back-end of the power conversion apparatus 10. FIG. 10 shows a block diagram of the second application embodiment of the power conversion apparatus of the present invention. A rectifier 40 is arranged in the front-end of the power conversion apparatus 10. The rectifier 40 is electrically connected to the power conversion apparatus 10 and the alternating current voltage source 50. The present invention is applied to a direct current to alternating current area or an alternating current to direct current area.

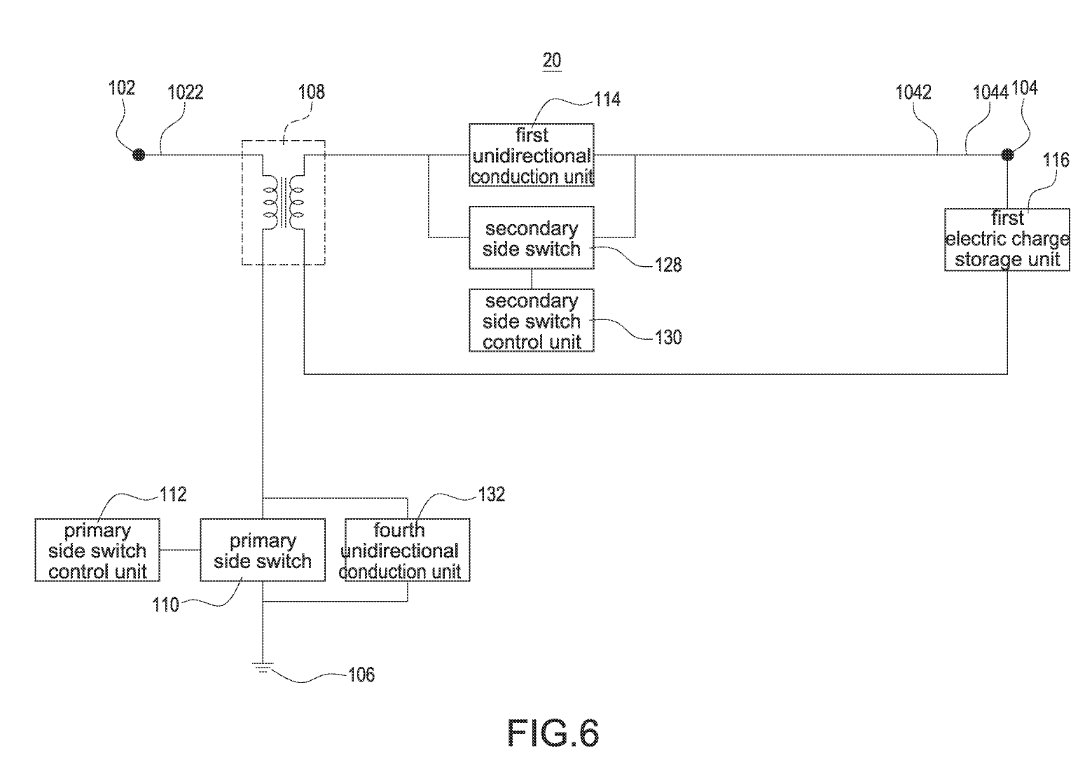

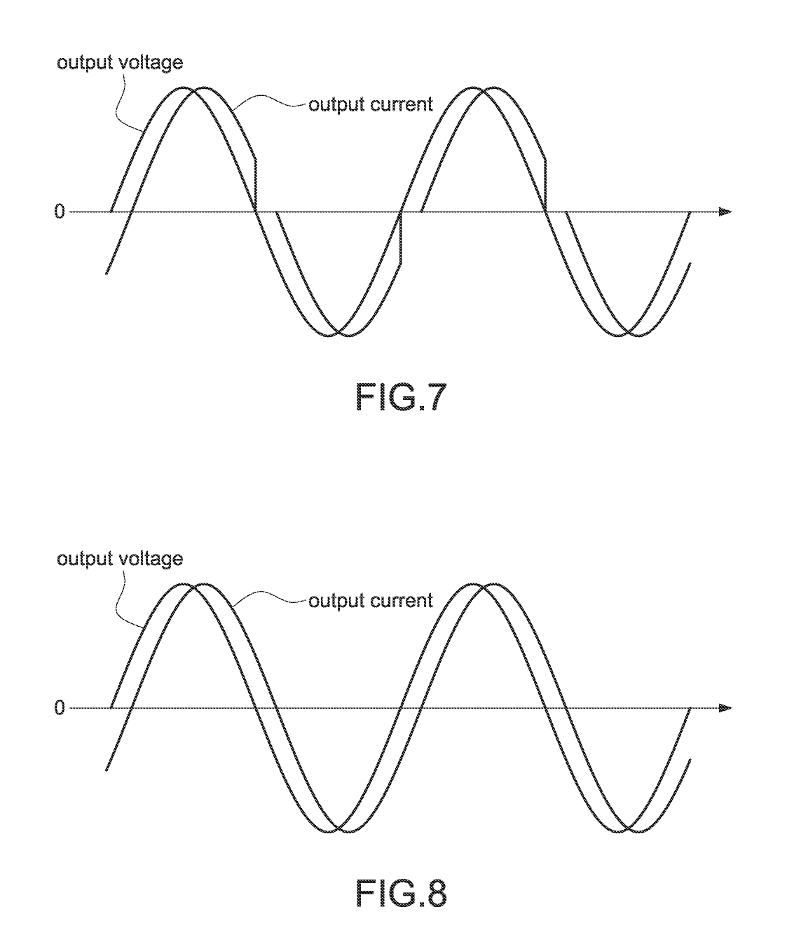

FIG. 6 shows a block diagram of the third embodiment of the power conversion apparatus of the present invention. The description for the elements shown in FIG. 6, which are similar to those shown in FIG. 4, is not repeated here for brevity. Moreover, the primary side switch control unit 112 is configured to turn off the primary side switch 110 and the secondary side switch control unit 130 is configured to turn on the secondary side switch 128 if the power conversion apparatus 20 is operated in the reactive power area. Therefore, the power conversion apparatus 20 has a function of reactive power compensation.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power conversion apparatus (10) comprising:
a power input side (102);
a power output side (104);
a power negative side (106);
a transformer (108) electrically connected to the power input side (102);
a primary side switch (110) electrically connected to the transformer (108) and the power negative side (106);
a primary side switch control unit (112) electrically connected to the primary side switch (110);
a first unidirectional conduction unit (114) electrically connected to the transformer (108) and the power output side (104);
a first electric charge storage unit (116) electrically connected to the transformer (108) and the power output side (104);
a second electric charge storage unit (118) electrically connected to the transformer (108), the first electric charge storage unit (116) and the power negative side (106);
a second unidirectional conduction unit (120) electrically connected to the transformer (108) and the primary side switch (110);
a mode change-over switch (122) electrically connected to the second unidirectional conduction unit (120), the transformer (108), the first electric charge storage unit (116) and the second electric charge storage unit (118);
a mode change-over switch control unit (124) electrically connected to the mode change-over switch (122);
a secondary side switch (128) electrically connected to the transformer (108), the power output side (104) and the first unidirectional conduction unit (114);
a secondary side switch control unit (130) electrically connected to the secondary side switch (128); and
a fourth unidirectional conduction unit (132) electrically connected to the primary side switch (110),
wherein the power conversion apparatus (10) is operated in an active power area if a value of an alternating voltage (1042) of the power output side (104) multiplied by a value of an alternating current (1044) of the power output side (104) is not less than zero; the power conversion apparatus (10) is operated in a reactive power area if the value of the alternating voltage (1042) of the power output side (104) multiplied by the value of the alternating current (1044) of the power output side (104) is less than zero;
wherein if the power conversion apparatus (10) is operated in the active power area and an absolute value of the alternating voltage (1042) of the power output side (104) is greater than an absolute value of an input voltage (1022) of the power input side (102), the mode change-over switch control unit (124) is configured to turn on the mode change-over switch (122), so that the power conversion apparatus (10) has functions of a reboost power converter;
wherein if the power conversion apparatus (10) is operated in the active power area and the absolute value of the alternating voltage (1042) of the power output side (104) is not greater than the absolute value of the input voltage (1022) of the power input side (102), the mode change-over switch control unit (124) is configured to turn off the mode change-over switch (122), so that the power conversion apparatus (10) has functions of a flyback power converter;
wherein the primary side switch control unit (112) is configured to turn off the primary side switch (110) and the secondary side switch control unit (130) is configured to turn on the secondary side switch (128) if the power conversion apparatus (10) is operated in the reactive power area; the mode change-over switch control unit (124) is configured to turn off the mode change-over switch (122); therefore, the power conversion apparatus (10) has functions of the flyback power converter and a function of reactive power compensation.

2. The power conversion apparatus (10) in claim 1, further comprising a second electric charge storage bypass circuit (126) electrically connected to the transformer (108), the first electric charge storage unit (116), the second electric charge storage unit (118), the mode change-over switch (122) and the power negative side (106), wherein the second electric charge storage unit (118) discharges to the power negative side (106) accurately according to the second electric charge storage bypass circuit (126) when the mode change-over switch control unit (124) is configured to turn off the mode change-over switch (122).

3. The power conversion apparatus (10) in claim 2, wherein the second electric charge storage bypass circuit (126) comprises a bypass switch (12602) electrically connected to the transformer (108), the first electric charge storage unit (116), the second electric charge storage unit (118), the mode change-over switch (122) and the power negative side (106).

4. The power conversion apparatus (10) in claim 3, wherein the second electric charge storage bypass circuit (126) further comprises a bypass switch control unit (12604) electrically connected to the bypass switch (12602) and the mode change-over switch control unit (124).

5. The power conversion apparatus (10) in claim 4, wherein the second electric charge storage bypass circuit (126) further comprises a voltage detection unit (12608) electrically connected to the transformer (108), the first electric charge storage unit (116), the second electric charge storage unit (118), the mode change-over switch (122), the bypass switch (12602) and the bypass switch control unit (12604).

6. The power conversion apparatus (10) in claim 5, wherein the first unidirectional conduction unit (114) is a first diode; a cathode of the first diode is electrically connected to the power output side (104); an anode of the first diode is electrically connected to the transformer (108); the second unidirectional conduction unit (120) is a second diode; a cathode of the second diode is electrically connected to the mode change-over switch (122); an anode of the second diode is electrically connected to the transformer (108) and the primary side switch (110).

7. The power conversion apparatus (10) in claim 6, wherein the secondary side switch control unit (130) is configured to turn off the secondary side switch (128) if the power conversion apparatus (10) is operated in the active power area.

8. The power conversion apparatus (10) in claim 6, wherein if the power conversion apparatus (10) is operated in the active power area, the secondary side switch control unit (130) is configured to turn on the secondary side switch (128) when the primary side switch control unit (112) is configured to turn off the primary side switch (110), and the secondary side switch control unit (130) is configured to turn off the secondary side switch (128) when the primary side switch control unit (112) is configured to turn on the primary side switch (110); therefore, a purpose of a synchronous rectification is achieved.

9. The power conversion apparatus (10) in claim 6, wherein an alternating current inverter (30) is arranged in a back-end of the power conversion apparatus (10), or a rectifier (40) is arranged in a front-end of the power conversion apparatus (10); the power conversion apparatus (10) is applied to a direct current to alternating current area or an alternating current to direct current area; the primary side switch (110) and the fourth unidirectional conduction unit (132) are integrated as a metal oxide semiconductor field effect transistor package or an insulated gate bipolar transistor package; the secondary side switch (128) and the first unidirectional conduction unit (114) are integrated as a metal oxide semiconductor field effect transistor package or an insulated gate bipolar transistor package.

10. A power conversion apparatus (10) comprising:
a power input side (102);
a power output side (104);
a power negative side (106);
a transformer (108) electrically connected to the power input side (102);
a primary side switch (110) electrically connected to the transformer (108) and the power negative side (106);
a primary side switch control unit (112) electrically connected to the primary side switch (110);
a first unidirectional conduction unit (114) electrically connected to the transformer (108) and the power output side (104);
a first electric charge storage unit (116) electrically connected to the transformer (108) and the power output side (104);
a secondary side switch (128) electrically connected to the transformer (108), the power output side (104) and the first unidirectional conduction unit (114); and
a secondary side switch control unit (130) electrically connected to the secondary side switch (128),
wherein the power conversion apparatus (10) is operated in an active power area if a value of an alternating voltage (1042) of the power output side (104) multiplied by a value of an alternating current (1044) of the power output side (104) is not less than zero; the power conversion apparatus (10) is operated in a reactive power area if the value of the alternating voltage (1042) of the power output side (104) multiplied by the value of the alternating current (1044) of the power output side (104) is less than zero;
wherein the primary side switch control unit (112) is configured to turn off the primary side switch (110) and the secondary side switch control unit (130) is configured to turn on the secondary side switch (128) if the power conversion apparatus (10) is operated in the reactive power area; therefore, the power conversion apparatus (10) has a function of reactive power compensation.
